(19) United States
(12) Patent Application Publication
(10) Pub. No.: US 2007/0166429 A1
(43) Pub. Date: Jul. 19, 2007

(54) Wrapping for used chewing gum

(76) Inventor: Miroslav Simonek, Ostrava-Poruba (CZ)

Correspondence Address: Oppedahl Patent Law Firm LLC, P.O. BOX 4850, FRISCO, CO, 80443-4850, US

(21) Appl. No.: 10/595,118

(22) PCT Filed: Aug. 12, 2004
(86) PCT No.: PCT/CZ04/00048

§ 371 Date: Feb. 23, 2006

(30) Foreign Application Priority Data
Aug. 25, 2003 (CZ) PV 2003-2282

(51) Int. Cl. A23G 4/00

(52) U.S. Cl. 426/3; 426/106

(57) ABSTRACT

The wrapping for used chewing gum is formed by an upper part (1) and a lower part (2) of identical form and size, applied together by their full surfaces, where both parts (1), (2) are provided with opposite situated vertical pre-scored lines (3) and where parts (1,2) are attached together along their margins partially, from one-third to one-half of the circumference of the parts (1,2).

### TECHNICAL FIELD

The invention applies to wrapping for used chewing gum and solves easy hygienic and ecological disposal of used chewing gum for improvement of environment.

### DESCRIPTION OF PRIOR ART

Used chewing gums, which were thrown out in places opened to the public, for example on pavements, floors of public buildings or on grass plots contributes to pollution of environment and substantially decrease utility and aesthetic value of public accessible places. Removal of used chewing gums is problematic, because they usually firmly stick to surface on which they lie.

It is known, that for removal of sticky chewing gums from pavements or floors, different machines are used. This machines use dissolving agent or local cooling to make mechanical releasing easier. High price and high operating costs are few disadvantages of using such machines. Other disadvantage is, that cleaning is made periodically.

To prevent above mentioned problems, keepers or owners of publically open places often use hygienic devices such as small containers, in which an exchangeable insert is pushed in. Disadvantage of those devices is that their usage is limited to placing into buildings, such as banks, hotels, restaurants and the like. This way does not solve discarding of used chewing gums in open areas, on pavements and grass plots.

Other known solution is a device that includes many wrapping papers. Each paper can be ripped off and used as a wrap for used chewing gum. Disadvantages of this solution are complicated handling, necessity of using both hands to open the wrapping paper, using bare hands or putting paper on to consumer's lips, that was already polluted by long time carrying in pocket or in bag.

### DISCLOSURE OF INVENTION

The aforesaid disadvantages are eliminated by the wrapping for used chewing gum according to invention, the disclosure of which consist in that it is formed by upper part and lower part of identical form and size. Parts are applied together by their full surfaces. Both parts are provided with opposite situated vertical pre-scored lines, where parts are attached together along their margins partially, from one third to one half of circumference.

Advantage of the wrapping for used chewing gum according to the invention is its hygienic, simple and practical use. Only one hand is sufficient for discarding of chewing gum. Opening of the wrapping is made by depressing with two fingers without direct contact of mouth and hands. It is also of an advantage that the wrapping can be carried in pocket, purse and the like with already used chewing gum for subsequent throwing-out into a wastebasket without risk of their fouling. The next advantage is aesthetic viewpoint, when form of the wrapping remains kept, therefore it affects as no waste. The main advantage of this invention is that the wrapping allows subsequent ecological disposal of used chewing gums, in case of throwing-out besides the wastebasket the gum does not stick to floor or to pavement, the wrapping can be easily cleaned by sweeping, therefore it finally conduces to environmental protection.

### DESCRIPTION OF THE DRAWINGS

In the attached drawings there is a schematically shown sample equipment embodiment according to invention, where in

FIG. 1 is a top view of expanded wrapping form before boding of parts, in the

FIG. 2 a front view of bonded wrapping, in the

FIG. 3 its side view and in the

FIG. 4 the opened wrapping in front view.

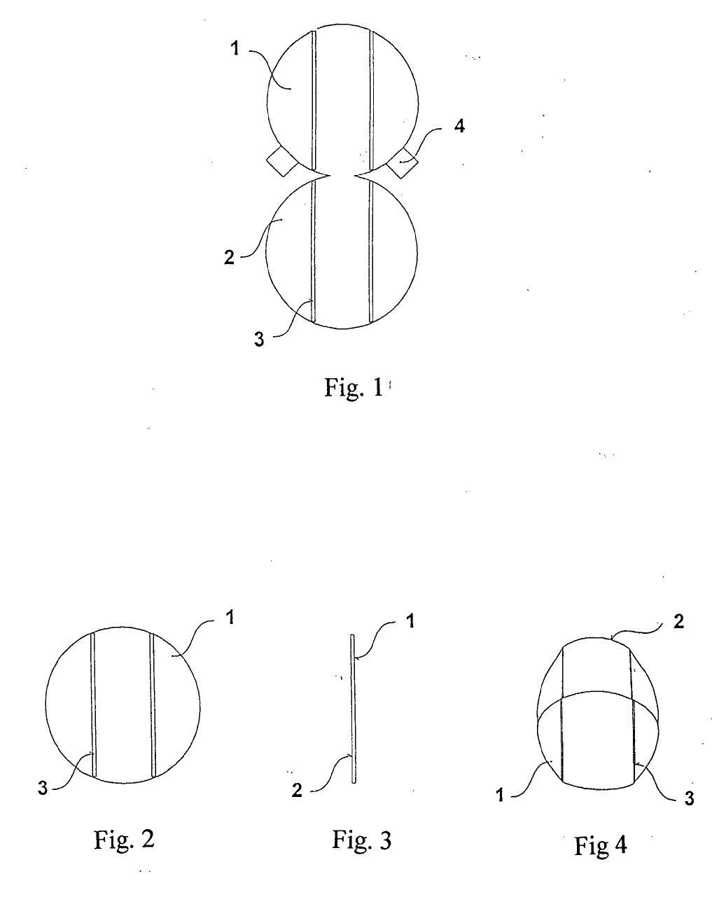

### EXAMPLE OF EMBODIMENT

According to sample embodiment the wrapping for used chewing gum is formed by the upper part 1 and the lower part 2. Both parts 1, 2 are of circular shape with identical diameter 30 mm and are made from one piece of recycled paper, which had been folded by such way to put both parts 1, 2 together with their whole surfaces. Both Parts 1, 2 are attached along their margins partially from one third to one half of circumference and are glued and secured together by means of the false flaps 4. Both parts 1, 2 are provided with vertical pre-scored lines 3 and the pre-scored lines 3 help to open the wrapping, by depressing two sides of the wrapping with two fingers. Used chewing gum is then spit into the wrapping from mouth without direct contact with fingers. Consequently the wrapping is thrown into a wastebasket.

Alternatively, for more aesthetic reason, the circular wrapping can be replaced by a square or rectangular one, eventually by a wrapping with rounded edges, furthermore a cylindrical, elliptical, floral and further ones. The paper wrapping can be replaced by a wrapping of other material and the parts 1, 2 can be circumferentially bonded by stitching, by a lock or by welding. For easy carrying of the wrapping in pocket or in purse a coin-sized wrapping is used to advantage.

### INDUSTRIAL APPLICABILITY

The wrapping according to the invention can be used for discharging of used chewing gums of all types. It can be attached directly when chewing gum is sold or can be available in restaurants, cultural centers and other places.

1. The wrapping for used chewing gum, characterized in that, is formed by upper part (1) and lower part (2) of identical form and size, applied together by their full surfaces, where both parts (1), (2) are provided with opposite situated vertical pre-scored lines (3) and where parts (1,2) are attached together along their margins partially, from one third to one half of circumference of parts (1,2).
